(19) United States
(12) Patent Application Publication
(10) Pub. No.: US 2007/0045417 A1
(43) Pub. Date: Mar. 1, 2007

(54) USB device having IC card reader/writer and flash memory disk functions

(76) Inventors: Ming-Chih Tsai, Shindian City (TW); Tzu-Chieh Hsiung, Shindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/211,677

(22) Filed: Aug. 26, 2005

(51) Int. Cl. G06K 7/06

(52) U.S. Cl. 235/441

(57) ABSTRACT

A universal serial bus (USB) device having integrated chip (IC) card reader/writer and flash memory disk functions is disclosed, in which an IC card reader/writer module and a flash memory disk module are integrated. The USB device comprises an IC card reader/writer module, a flash memory disk module and a USB interface. Through the USB interface, data in the USB device may be transmitted to an external electronic device such as a computer connected thereto so that an IC card may be subject to an authentication process and a data read/write process. Also, the flash memory disk module may serve as a portable hard disk of the external electronic device since data in the flash memory disk module and the electronic device may be transferred between each other.

### BACKGROUND OF THE INVENTION

1. Field of the Invention

The present invention relates to a universal serial bus (USB) device, and particularly to a USB device having IC card reader/writer and flash memory disk functions.

2. Description of the Prior Art

FIG. 1 shows a prior art integrated chip (IC) card reader 1. For the most part, such IC card reader/writer 1 is a peripheral device having a single function of data read or write to a computer 14 and existed in a form of being embedded in an electronic device or the computer 14. Alternatively, the IC card reader/writer 1 may be coupled to the electronic device or computer 14 through a connection interface thereof as an external device form. No matter which form the IC card reader/writer takes, the IC card reader/writer is not popular up to an extent that every computer 14 is equipped with it. In addition, such IC card reader/writer 1 is often used with different computers 14 as a user thereof moves. However, it is sometimes hard to find a computer equipped with such reader and thus it is necessary to carry such an IC card reader/writer in hand when it is possible to access the IC card. Unfortunately, the conventional IC card reader/writer of the single function (e.g. data read or write) has the disadvantages of being large in volume and thus having poor portability. Further, the IC card reader/writer has to be detached and attached when used with from one computer 14 to another computer 14 and driver program and software associated with the IC card reader/writer have to be installed to the currently used computer 14 (used with the IC card reader).

In this regard, how to exempt the clumsy IC card reader/writer and the associated software from being necessary to be carried to a place where a user thereof is required to have an access thereto is apparently an important issue in the field. The Inventors of the present invention envisages that if the IC card reader/writer function can be integrated into an EZ drive of flash memory disk, then carrying the IC card reader/writer may not become an additional burden to the user. Based on this concept, this invention is thus set forth.

### SUMMARY OF THE INVENTION

According to the present invention, a single universal serial bus (USB) device having IC card reader/writer and hard disk of flash memory functions is provided. As a flash memory disk, a USB interface is provided on the USB device for data transfer between the USB device and other electronic devices like computers. As an IC card reader, an IC card interface is provided on the USB device for placement of the IC card and communication with an IC card through a direct contact between the IC card connection interface of the card reader/writer and metal connection points of the IC card. Further, power required for access to the IC card is also provided through the USB interface. In addition, data transfer may be conducted between the USB device and the external electronic device, such as a computer or a notebook computer so that the USB device and external electronic device may have various integrated applications, such as user identification of the IC card and processing of data read and writing of the IC card. In this manner, the IC card read/write module may serve as an intermediate for data transmission between the IC card and the external electronic device.

The USB device having IC card reader/writer and flash memory disk functions according to the present invention may be connected through a USB reception end control hardware module interface to an external device or product having the same interface, such as a computer and a personal digital assistant (PDA). The USB device is capable of determining which type an instruction issued from the external device connected thereto is, such as an instruction for driving an IC card reader/writer module, the flash memory disk module or the function combining the functions of IC card, IC card reader and flash memory disk. In the case of an instruction for driving the IC card read/write module, the IC card is requested to be inserted into the connection slot of the IC card reader/writer before a command issued from the external active electronic device is transmitted to the IC card thru the reader/writer, and then the IC card responds the corresponding response data of the command back to the external electronic device. In the case of an instruction for driving the flash memory disk module, the flash memory disk module is triggered based on the commands issued by the external active electronic device to perform the data read from and writing to the flash memory equipped in the usb device. Further, instructions for integration functions or extended functions can be supportable in the invention so that the IC card read/write module, IC card and flash memory disk module may be integrated to provide various applications. For example, a provided integration command may be issued to specify data files in the flash memory disk module of the USB device as input data and then the input data may be outputted after being subject to an encryption or decryption process thru the cipher operation functions and the cryptographic key in the IC card inserted to the IC card read/write module of the USB device.

The combined device of IC card reader/writer and flash memory disk modules may be formed as a portable flash memory disk generally used but with the additional IC card reader/writer function, which is compact, slight and thus convenient to be carried in hand. The USB device can be connected with some external electronic device like computer or consumer product and operated in a hot plugging manner with respect to the device, which also supplies the required power of the usb device.

In the USB device, the functions of the IC card reader/writer and flash memory disk are achieved by the following design architecture. A main control unit is provided to distinguish and determine automatically which type the instruction from the connected electronic device is and which function of IC card reader/writer or flash memory disk intended to be activated in response to the instruction. A USB control unit is provided to be able to receive a command issued from the main control unit and transmit data back to another externally interfaced USB device of the connected electronic device. In addition, the USB control unit device also detects any external command issued thru the interfaced USB connector of the external electronic device by the implemented USB transmission protocol. As such, the main control unit is notified by the USB control unit to perform a data receiving operation. Then, In the case of received command belonging to the category of IC card reader/writer or requiring access the IC card, the IC card reader/writer is dictated to issue the instruction to the IC card by the command issued from the main control unit and then receives a response signal from the IC card to notify the main control unit to control the USB control unit so as to transmit data back to the external USB device. In another case of received command belonging to the category of flash memory or requiring access the flash memory, the flash memory disk receives a command issued from the main control unit to execute an instruction according to the external USB device. As such, data processing including data storing and/or reading with respect to the flash memory disk module is achieved.

The IC card read/write module comprises an IC card connector having resilient metal connection pin with which the metal contact points of an inserted IC card are contacted so that electric signals and data may be transmitted/received between the IC card connector and the IC card. For the better design of the physical mechanism, the IC card read/write module may provide the IC card slot or seat made by plastic or other rigid material to facilitate fixation of the IC card so that the metal contact points of the IC card and the metal connector of the IC card read/write module can be assured to closely contact with each other and guarantee quality transmission of the electric signals in-between.

A physical metal connection interface of the USB interface is equipped at the front end of the USB device with combined functions. The physical metal connection interface may be connected with an external electronic device having the connective USB interface at an upper end thereof and connected electrically to a USB control unit in the USB device at another end.

In addition, the main control unit, USB control unit depicted above, IC card read/write module and flash memory disk module are connected electrically.

### BRIEF DESCRIPTION OF THE DRAWINGS

The drawings disclose an illustrative embodiment of the present invention which serves to exemplify the various advantages and objects hereof, and are as follows:

FIG. 1 shows schematically a prior art integrated usage architecture of chip (IC) card reader/writer and external device;

FIG. 2 shows schematically a three dimensional graphics of one of the possible structure (briefly as Structure 1 hereafter) of the USB device according to the present invention;

FIG. 2-1 shows schematically a perspective view of Structure 1 of an IC card reader/writer module of a universal serial bus (USB) device according to the present invention;

FIG. 2-2 shows schematically a perspective view illustrating to open the extensible arm of a rotatory card frame of an IC card reader/writer module in Structure 1 according to the present invention;

FIG. 2-3 shows schematically a perspective view illustrating an insertion direction of an IC card of ID-000 type to Structure 1 according to the present invention;

FIG. 2-4 shows schematically a perspective view illustrating a seated and connection state of the IC card of ID-000 type to Structure 1 according to the present invention;

FIG. 2-5 shows schematically a perspective view illustrating an insertion direction of an IC card of ID-1 type to Structure 1 according to the present invention;

FIG. 2-6 shows schematically a perspective view illustrating a seated and connection state of the IC card of ID-1 type to Structure 1 according to the present invention;

FIG. 3 shows schematically a three dimensional graphics of an IC card reader/writer module of the USB device of another possible structure (briefly as Structure 2 hereafter) according to present invention;

FIG. 3-1 shows schematically a perspective view illustrating a horizontally open the two extensible arms of the rotatory card frames of the IC card reader/writer module in Structure 2 according to the present invention;

FIG. 3-2 shows schematically a perspective view illustrating a retracted state of the two extensible arms of the rotatory card frames in Structure 2 according to the present invention;

FIG. 4 shows schematically a block diagram of the USB device according to the present invention;

FIG. 5 shows schematically a diagram illustrating a connection state according to the present invention where the USB device is connected to a computer;

FIG. 6 shows schematically a three dimensional graphics of the USB device of another possible structure (briefly as Structure 3 hereafter) with an open slot in the flank and bottom corner side of the IC card reader/writer module of the universal serial bus (USB) device according to the present invention;

FIG. 6-1 shows schematically a perspective view of the IC card reader/writer module of the USB device in Structure 3 according to the present invention;

FIG. 6-2 shows schematically a perspective view illustrating an insertion direction of an IC card into the USB device of Structure 3 according to the present invention;

FIG. 7 shows schematically a perspective view of another possible structure (briefly as Structure 4 hereafter) of the USB device with an open slot in the flank side of the IC card reader/writer module according to the present invention;

FIG. 8 shows a perspective view of another possible structure (briefly as Structure 5 hereafter) of the USB device with two rotationally covers able to be opened according to the present invention where a right cover and a left cover are in a retract state;

FIG. 8-1 shows schematically a perspective view of the USB device of Structure 5 according to the present invention where the right and left covers are rotationally opened in an extension state to make an IC card able to insert to the IC card reader/writer module;

FIG. 9 shows schematically a perspective view of another possible structure (briefly as Structure 6 hereafter) of the USB device according to the present invention where the right and left covers are in a retract state; and

FIG. 9-1 shows schematically a perspective view of the USB device of Structure 6 according to the present invention where the right and left covers are rotationally opened to 180 degree of angle in a horizontal extension state to make an IC card able to insert to the IC card reader/writer module;

### DETAILED DESCRIPTION OF THE PREFERRED EMBODIMENT

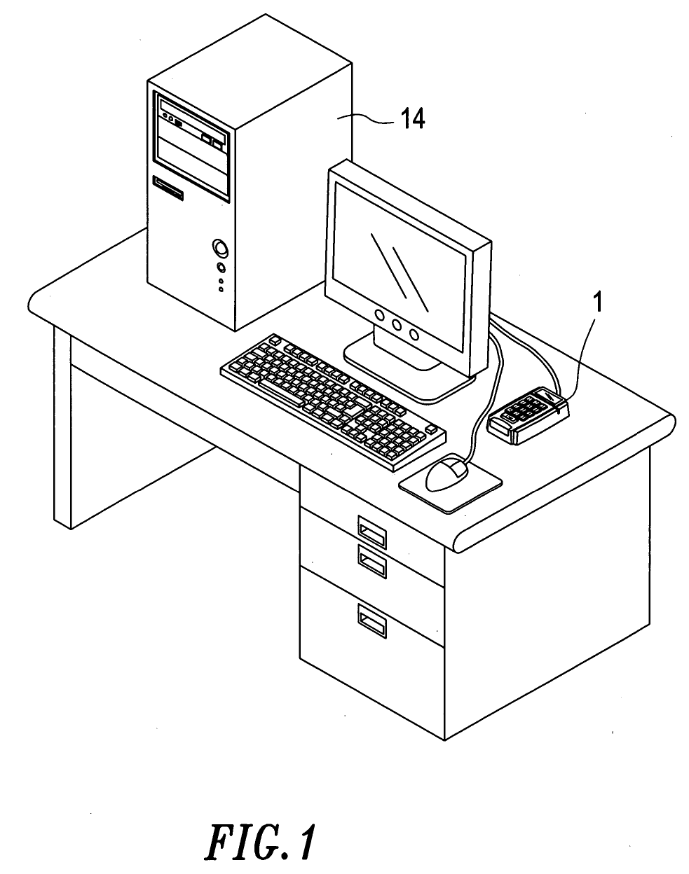

In this invention, a universal serial bus (USB) device having IC card reader/writer and hard disk of flash memory functions is disclosed. As a flash memory disk, a USB interface is provided on the USB device for data transfer between the USB device and other electronic devices. As an IC card reader, the USB device is equipped with software and hardware features of an IC card reader. FIG. 2-1 through FIG. 2-6 shows a possible form of the USB device having IC card reader/writer and flash memory disk functions according to the present invention, and the form of the USB device is referred to as structure 1. As shown, an IC card reader/writer module 2 comprises an IC card read/write interface (or connector) 20, an IC card seat 21, the USB interface 22, a hard disk memory 23, an IC card positioned frame 24 and a card positioned slot 25. Beneath the IC card seat 21 of the IC card reader/writer module 2, the hard disk module of flash memory 23 is disposed, the circuit inside the IC card seat 21 is connected electrically to an IC card read/write interface 20. With respect to the IC card reader/writer module 2, the USB interface 22 is disposed at an end thereof and the IC card positioned frame 24 and a card positioned slot 25 are disposed at another end thereof. A rotating cylinder 240 is connected with the IC card positioned frame 24 and disposed at a corner side on the IC card seat 21. The IC card positioned frame 24 has an extension at a upper side thereof as a stop 241 to help the inserted IC card positioned, the stop 241 having a traverse groove 242 disposed on a central portion of a side of the stop 241 thereof. Similarly, a traverse groove 250 is also disposed on the central portion of a side of the card positioned slot 25 thereof. The traverse groove 242, 250 are disposed in parallel so as to provide a positioning effect to the inserted IC card 5 (or 3) to be read/written by the IC card reader/writer module 2. At another end of the IC card positioned frame 24 near the insertion slot of an IC card, a stop arm 243 is disposed and an opening slot 244 is formed at a central portion of a side of the stop arm 243. Through the opening slot 244, the IC card 3 may be inserted into the IC card reader/writer module 2 and then traverse along groove 242 and 250 and finally be blocked for proper positioning. When the proper positioned IC card 3 (or 5) comes into contact with the IC card interface 20 thru the opening slot 244, a optional LED or LCD of the USB device can be activated to illuminate indicating properly positioning of the chip of IC card 3 (or 5) has been finished. Specifically, the positioning function is achieved by providing resilient metal connector (20) on the IC card seat 21 since the chip of the IC card 5 may be properly contacted to the metal connections of the IC card seat 21. As such, electric signals and data may be transmitted between the metal connections and the chip 3. If necessary, the rotational IC card positioned frame 24 may be made to be easily traversable of IC card so that it may be assured that the chip of the IC card and the metal connector(20) may be closely contacted. When the IC card positioned frame 24 rotates and extends to the right side up to 90 degree of angle, the IC card 5 of a standard type (type ID-1) may be received therein. As a result, IC cards of different sizes may be received and positioned therein.

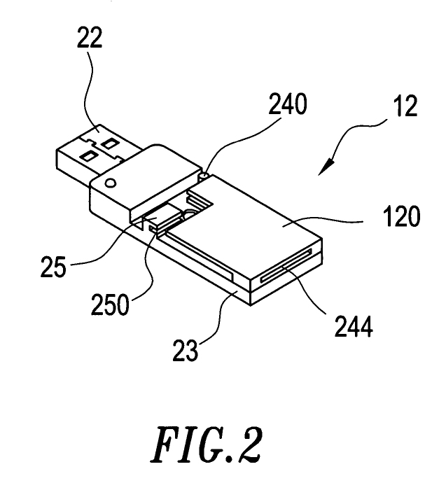

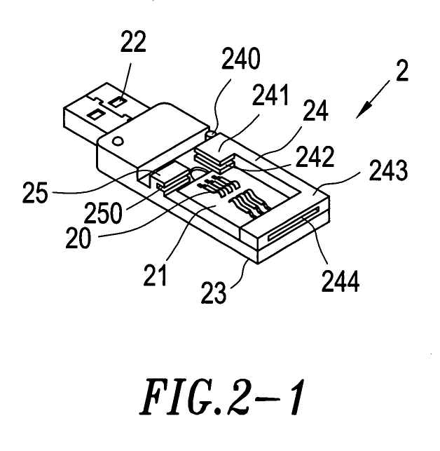

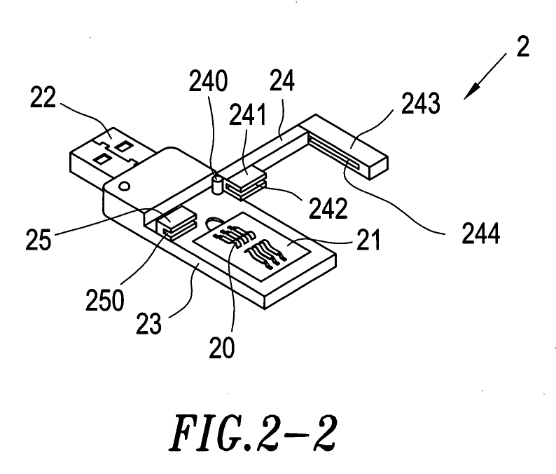

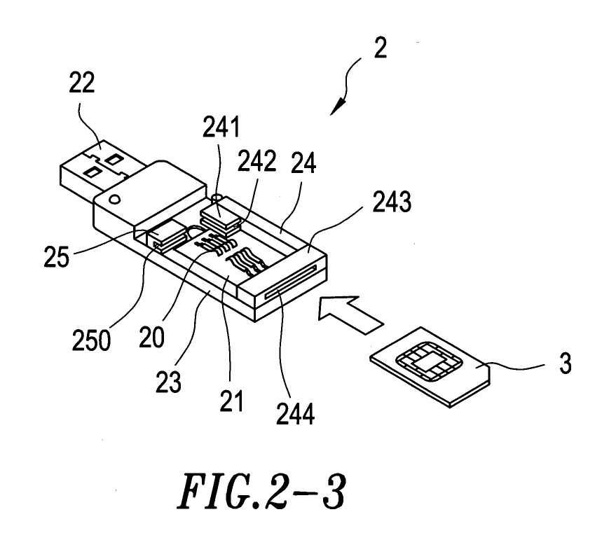

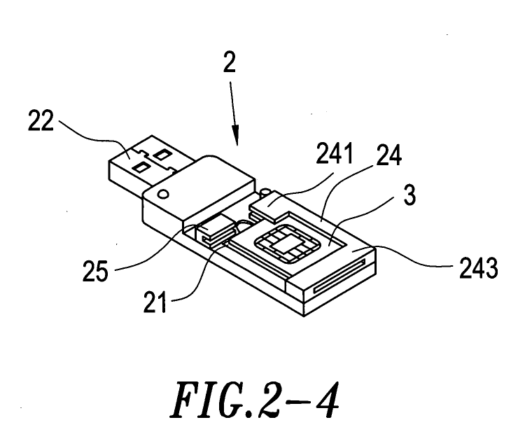

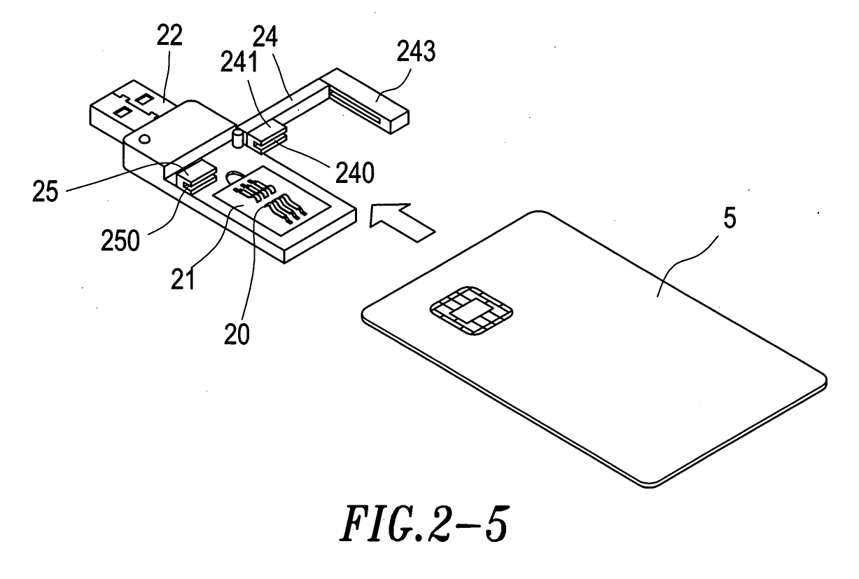

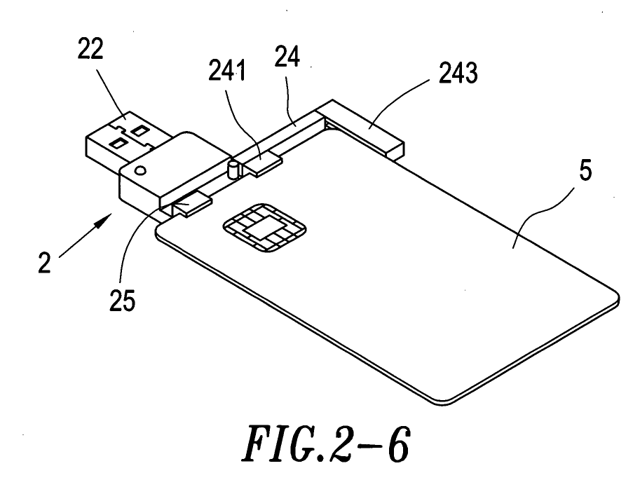

In conclusion, Structure 1 may be summarized through FIG. 2. As shown, an usb device 12 with an IC card reader/writer has the hard disk of flash memory 23 disposed on a bottom thereof, the USB interface 22 disposed at an end thereof and an IC card reader/writer frame 120 card positioned slot 25 disposed at the other end thereof. The rotating cylinder 240 is connected with the IC card reader/writer frame 120. The card positioned slot 25 has a traverse groove 250 at a central portion of lower and right sides thereof, the traverse grooves 250 being disposed in parallel so as to provide a positioning effect to the chip 3. The IC card reader/writer frame 120 has a opening slot 244 disposed at an end thereof, through which the chip card 5 may be inserted for closely and fixed electrical connection. When the IC card reader/writer frame 120 rotates and extends right up to 90 degree of angle, the IC card 5 of a ID-1 type may be received therein. As a result, IC cards of different sizes may be received and positioned therein.

Now another possible form of the USB device according to the present invention (referred to as Structure 2) will be described below with reference to FIG. 3-1 through FIG. 3-2. As shown, two rotational arms 26,27 are disposed on respective sides of the IC card reader/writer module 2 and may extend from the left and right sides of the IC card reader/writer module 2. At the rotational arms 26,27, two guiding grooves 260,270 are formed, between which the IC card 5 may be inserted. Namely, the two rotational arms 26,27 are used to guide an IC card 5 to be traversed within a region limited between the guiding grooves 260,270. When the rotational arms 26,27 move towards each other to be a retracted state, the grooves of 260,270 are combined and define a width of the IC card 3 (ID-000 type) so that the IC card 3 may be received and properly positioned therein.

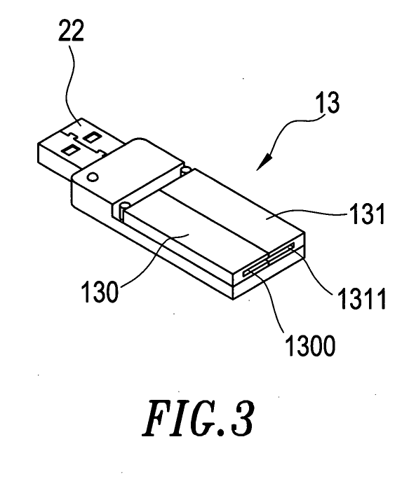

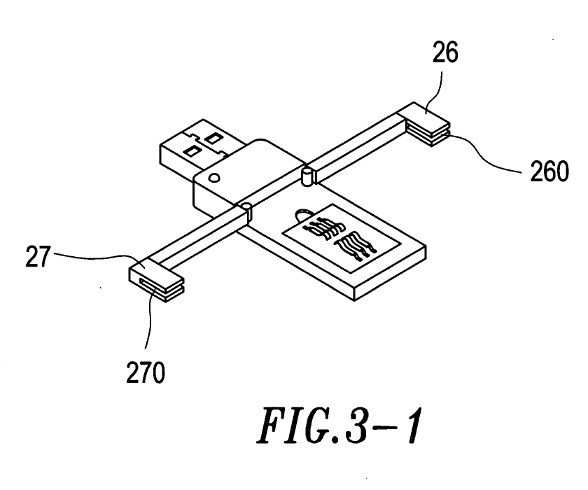

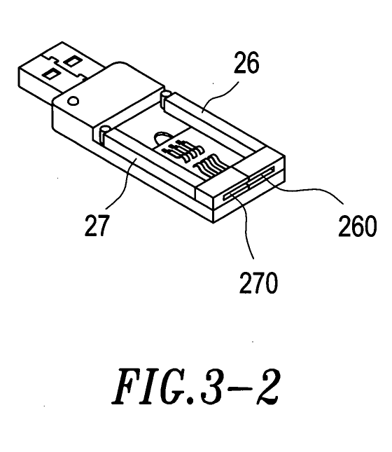

In conclusion, Structure 2 may be summarized through FIG. 3. As shown, on the left and right sides of the IC card reader/writer module 2, two rotational arms 130,131 are disposed which may rotate up to 90 degree of degree to extend the card holding frames of the left and right sides of the IC card reader/writer module 2. Each of the rotational arms 130,131 has a guiding groove 1300 (1311) between which the IC card 5 can be received. Namely, the two extended arms 130,131 is used to guide an IC card 5 to be received within a region defined between the grooves 1300,1311. When the rotational arms 130,131 move towards each other to be a retracted state, the grooves 1300,1311 define the width of the IC card 3 so that the IC card 3 may be received and properly positioned therein.

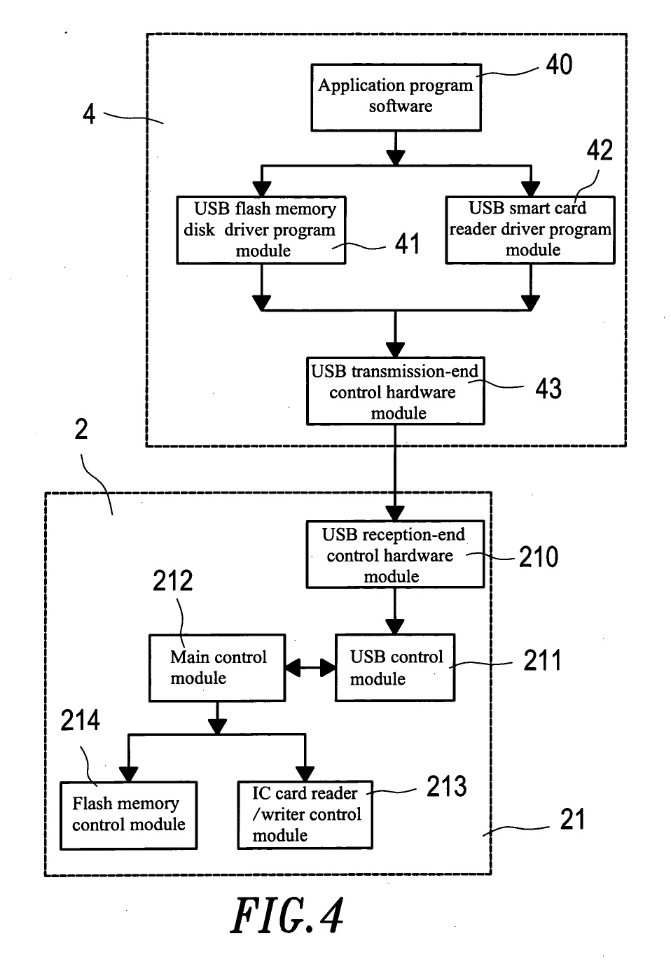

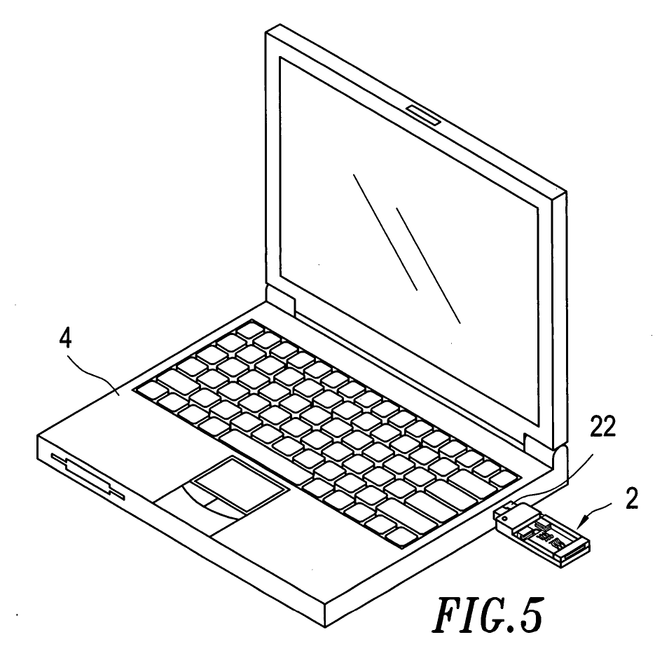

FIG. 5 is a schematic diagram of a physical application of the USB device according to the present invention where the USB device is inserted into a computer. FIG. 4 is a logical block diagram of the physical application of flash disk and smart card reader/writer shown in FIG. 5. As shown in FIG. 5 and FIG. 4, the USB interface 22 of the IC card reader/writer module 2 is connected to computer 4 with application program software 40 and a USB flash memory disk driver program module 41 and a USB smart card reader driver program module 42. Through a USB transmission-end control hardware module 43, the USB interface 22 can connect with the external device—computer 4. The USB device of the invention has a hot plugging end, which is connected to a USB control module 211 through a USB reception-end control hardware module 210 and the USB control module 211 and a main control module 212 are connected electrically to each other. Meanwhile, the main control module 212 is connected to the flash memory control module 214 and an IC card reader/writer control module 213. As such, the flash memory disk function and the IC card reader/writer function of the USB device according to the present invention may be switched by the main control module 212.

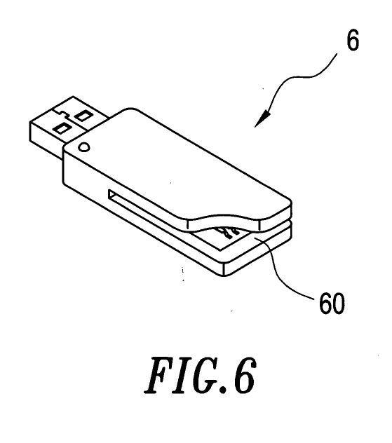

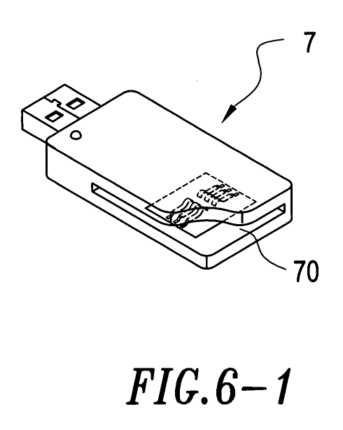

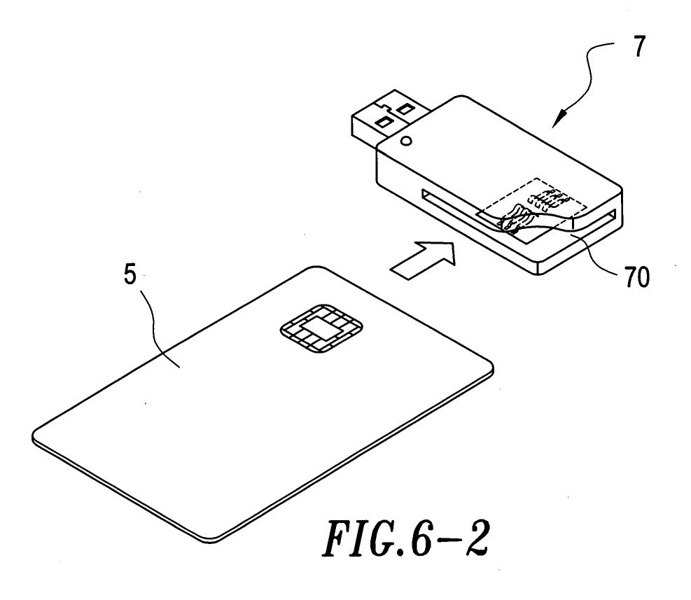

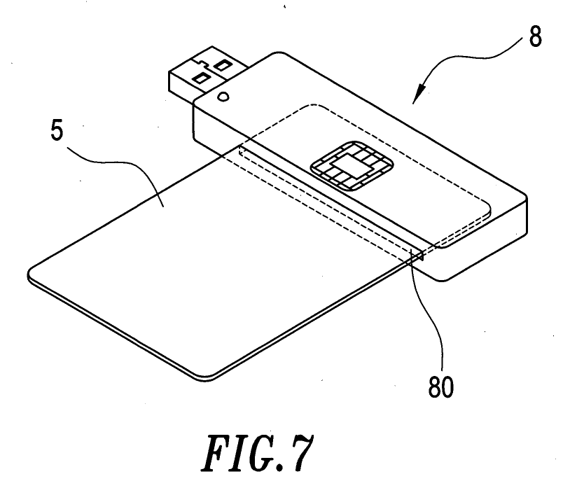

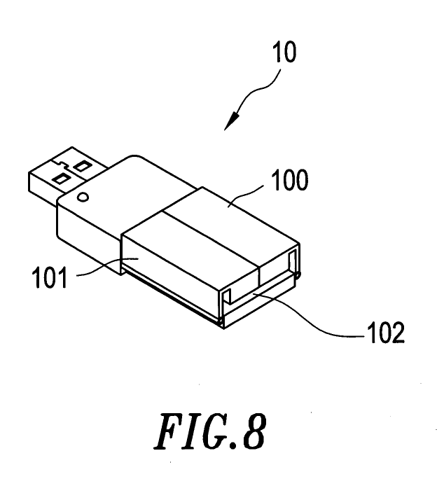

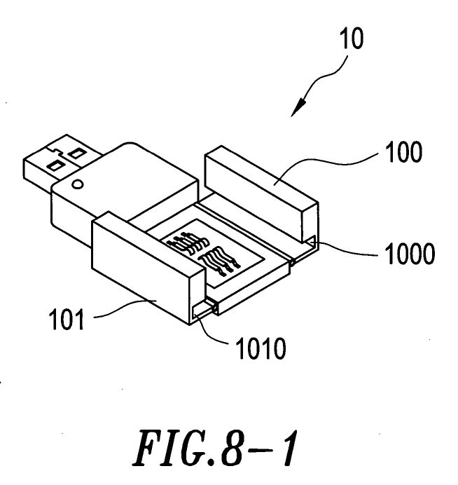

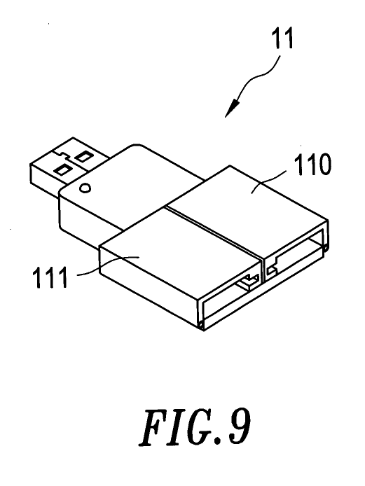

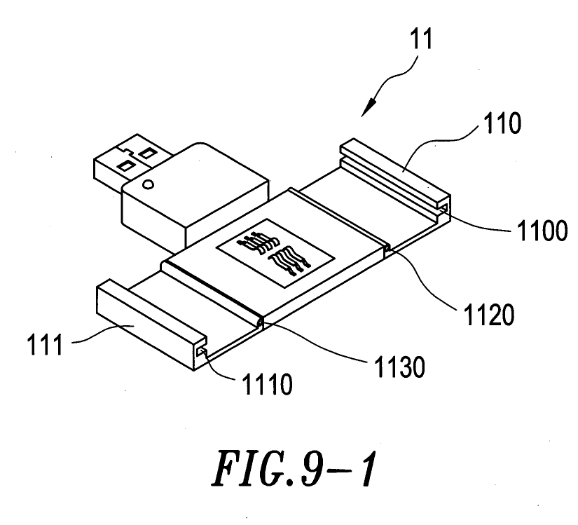

The following description will be made to other possible forms of the USB device of this invention. FIG. 6-1 through FIG. 6-2 and FIG. 6 show yet another form of the USB device, Structure 3, according to the present invention. FIG. 7 shows an alternative and improved form of Structure 3 shown in FIG. 6, Structure 4, according to the present invention. FIG. 8 and FIG. 8-1 show still another form of the USB device, Structure 5, according to the present invention. FIG. 9 and FIG. 9-1 show an alternative and improved form of Structure 5 shown in FIG. 8, Structure 6, according to the present invention.

According to the USB device of Structure 3 shown in FIG. 6-1 through FIG. 6-2 and FIG. 6, an USB device with IC card reader/writer module 6 may be inserted into a side of the computer 4 through USB interfaces in a hot plugging manner (refer to FIG. 5). To achieve positioning and reception of the IC card, an open IC card reception region 60 is formed in the IC card reader/writer module 6 for insertion of the IC card of different sizes. Alternatively, a close IC card reception region is formed in the other side of the IC card seat 70 of the IC card reader/writer module 7 for properly positioning of the IC card. As such, data in the IC card may be read out for data processing by connecting the IC card reader/writer modules 6 (or7) to the computer 4.

Referring to FIG. 6-2, it is illustrated that an IC card of a type of ID-1 is inserted to the IC card reader/writer modules of the USB device along two sides of the IC card reception region. In this manner, the IC card is properly positioning by its forward insertion finally blocked by the other two closed sides and then chip pins of the card closely contacted with the metal connector of the IC card reader/writer module.

Referring to FIG. 7, Structure 4 of the USB device of this invention is shown therein, which is modified and improved from Structure 3 shown in FIG. 6. As compared to Structure 3, Structure 4 stretches in the length of the flank side of the USB device so as to cover the overall width of an IC card. An open IC card reception region 80 is formed in the IC card reader/writer module 8 so that an IC card 5 may be inserted into the module 8 at a proper contact position along a horizontal direction. Specifically, internal guiding grooves for IC card insertion (not shown in FIG. 7) are formed on two sides of the open IC card reception region 80 so that the IC card may be inserted smoothly and precisely positioned, vertically and horizontally, and closely contacted with the metal connection points of the IC card connector. On each end of the two side guiding grooves 80, a protrusion, like a stop, is formed, serving as a position stop point for the inserted IC card. By means of the guiding grooves and stop, a good positioning mechanism is provided and the IC card 5 is properly contacted with the card reader/writer module through the positioning mechanism.

Referring to FIG. 8 and FIG. 8-1, yet another form of the USB device according to the present invention is schematically shown therein. On the USB device with an IC card reader/writer module 10, a right cover 100 and a left cover 101 are formed. When the right and left covers 100,101 are folded outward to 90 degree of angle, two grooves 1000,1010 are designed near the rotational corner of the covers 100,101. When the right and left covers 100,101 are not outward folded to stay at a retracted state, a small IC card (e.g. ID-000 type) may be inserted through an IC card reception region 102 defined by the closed covers 100,101. Alternatively, the right cover and left covers may be lifted upward and then rotated 90 degrees outward about a right rotation axis and a left rotation axis, respectively. In this case, the grooves 1000,1010 are disposed in parallel and form a IC card reception region large up to that a large IC card (e.g. ID-1 type) may be received therein. Further, a guiding groove for positioning of the IC card is provided at interior part of an outer rim of each of the right and left covers. By means of the guiding grooves, the IC card may not only be received but also be prevented from moving vertically. Further, the IC card may thus be facilitated to have a good contact with the metal connections located at a base of the IC card reader/writer and positioned properly in a horizontal direction. For the small IC card (type ID-000), the chip of such card is connected with the metal connections. To enable the small IC card to contact with a positioning point located at the end of the IC card reception region for the insertion of the IC card, it is necessary to restore the lifted and rotated right and left covers 100,101 back to their retracted state. Then, the small IC card is directed to be inserted through the IC card reception region 102 and is positioned vertically and horizontally through small guiding grooves at the right and left sides of the right and left covers. In each of the small guiding grooves, a protrusion is formed on an end thereof as a stop for the forwardly inserted IC card. In this manner, metal connections of the IC card may be closely contacted with the metal connection points of the card connector.

Referring to FIG. 9 and FIG. 9-1, an alternative and improved form of Structure 5, Structure 6, according to the present invention is schematically shown therein. On an IC card reader/writer module 11, a right cover 110 and a left cover 111 are formed. The right and left covers 110,111 may be rotated 180 degrees of angle outward about an axis 1120 and an axis 1130, respectively. The outward right and left covers 110,111 may design two grooves 1100,1110 at the farthest end of the extended wings. The two grooves 1100,1110 are formed in right and left sides of the covers 110,111 to provide a vertical and horizontal positioning function to the IC card. In each of the grooves 1100,1110, a protrusion is formed on the end thereof as a stop for the forwardly inserted IC card. In this manner, metal connections of the IC card may be closely contacted with the metal connections of the card connector.

The USB device having IC card reader/writer and flash memory disk functions has at least the following advantages. 1. Good portability. 2. Space saving. 3. Compactness and slightness. 4. Being plug-and-play. 5. Indicator to show properly positioning of the IC card.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A universal serial bus (USB) device having IC card reader/writer and flash memory disk functions, comprising:
an IC card read/write module;
a flash memory disk module; and
a USB interface through which the IC card read/write module or the flash memory disk is in data communication with an external electronic device connected thereto,
Wherein the USB device itself is capable of determining which type an instruction issued from the external electronic device is and thus determining which one of the IC card read/write module or the flash memory disk module is to be driven and, if the IC card read/write module is to be driven, an IC card is requested to be inserted with respect to the IC card read/write module so that the external electronic device issues a command to the IC card and the IC card makes a response signal to the external electronic device, however, if the flash memory disk module is to be driven, the external electronic device accesses the flash memory disk module through the USB interface,
Wherein the USB device is manufactured in a compact and slight form so that the USB device is capable of being had in hand conveniently, being operated in a hot plugging manner with respect to the external electronic device and enabling the IC card to come into data communication with the external electronic device so that the data in the IC card is stored in its nonvolatile memory like flash memory and accessed by the external electronic device through the USB interface for authentication, data read/write of the IC card and other related applications,
Wherein the USB device is characterized in that:
a USB physical metal connection interface is disposed to a front end of the USB device at one end for connection with another external electronic device having the same USB interface and connected electrically to a USB control unit in the USB device at another end (back end), in addition, the main control unit, the USB control unit, the IC card read/write module and the flash memory disk module are electrically connected,
Wherein the main control unit determines automatically which type the instruction from the connected electronic device is and which function(s) of the IC card read/write module or/and the flash memory disk module is intended to be activated according to the instruction, the USB control unit is able to receive a command issued from the main control unit and then transmits data back to the another externally interfaced USB device of the connected electronic device. In addition, the USB control unit device also detects any external command issued thru the interfaced USB connector of the external electronic device by the implemented USB transmission protocol. As such, the main control unit is notified by the USB control unit to perform a data receiving operation. Then, In the case of received command belonging to the category of IC card reader/writer or requiring access the IC card, the IC card reader/writer module is dictated to issue the instruction to the IC card by a command from the main control unit and then receives a response signal from the IC card so as to notify the main control unit to control the USB control unit and then transmit data back to the external USB device. In another case of received command belonging to the category of flash memory or requiring access the flash memory, the flash memory disk receives a command issued from the main control unit to execute an access data instruction according to the external USB device, and
Wherein the smart card reader/writer module of the USB device has an IC card seat thereon having resilient IC card connector and data are transmitted between IC card and the module. In addition, the IC card reader/writer module may optionally have a movable IC card positioned frame so that the IC card and the metal connector of the IC card reader/writer module are assured to be closely contacted with each other.

2. The USB device according to claim 1, wherein a “L” shaped rotating arm having a rotation axis on an upper end thereof is disposed on one or both of a right side and a left side of the IC card read/write module, the rotation axis being allowed to rotate 90 degrees outward as an extension state and grooves are formed in the rotating arm at an interior side thereof so that the IC card is allowed to be inserted and forward along a lower rim of IC card read/write module to a proper positioning point when the rotating arm is in the extension state,
Wherein the “L” shaped rotating arm is retracted at a side rim and a lower rim of the USB device as a retracted state when the IC card is not requested to be inserted into the IC card read/write module,
Wherein the rotating arm is rotated 90 degrees of angle outward to a predetermined position when the IC card is requested to be inserted into the IC card read/write module,
Wherein an open IC card reception region is formed at a lower rim and a side of the IC card read/write module so as to receive the IC card therein, the open IC card reception region providing a vertical positioning to the IC card inserted therein and enabling the chip pins of the IC card and the metal connector of the IC card positioned frame to closely contact with each other, and
Wherein the IC card is inserted to reach the positioning point with an aid of the “L” shaped rotating arm which provides a stop forwarding positioning and a groove along the forwardly inserted direction of the IC card when being rotated 90 degrees outward.

3. The USB device according to claim 1, wherein an indicator is provided on the USB device to indicate that the chip pins of the IC card and the metal connector of the IC card seat have been closely contacted with each other and an open IC card reception region having guiding grooves of “L” shape formed at two sides thereof having a protrusion formed at a farthest end and two sides adjacent thereto from the insertion slot of the IC card reader/writer module. Therefore, the IC card is allowed to be inserted horizontally into the IC card reception region along the guiding grooves, and the open IC card reception region and the guiding grooves provide a proper vertical and horizontal positioning effect to the inserted IC card.

4. The USB device according to claim 1, wherein an open IC card reception region is formed at a flank side of the IC card read/write module through which the IC card is inserted horizontally into the IC card read/write module at a proper position and guiding grooves are provided in two sides of the open IC card reception region so that the IC card is allowed to be inserted horizontally into the open IC card reception region and closely contacted with the metal connector of the IC card seat, wherein a protrusion is provided as a stop at a farthest end of the open IC card reception region from the insertion slot of the IC card reader/writer to serve as a positioning point for the inserted IC card. The guiding grooves provide a proper positioning effect to the IC card with the IC card read/write module.

5. The USB device according to claim 1, wherein the length of the IC card reception region of the USB device is extended to sufficiently cover the overall width of the IC card, and the IC card reception region is provided in a flank side of the USB device. IC card reception region provides a positioning effect to the inserted IC card in a proper contact with the metal connector of the IC card seat. The IC card reception region is provided with guiding grooves through which the forwardly inserted IC card is provided with a vertical and horizontal positioning effect and contacted properly with the metal connector of the IC card seat and a protrusion being provided as a stop at a farthest end from the IC card reception region to serve as a positioning point for the inserted IC card.

6. The USB device according to claim 1, wherein a right movable cover and a left movable cover are disposed on an upper side of the USB device, the IC card reception region being extended to an extended IC card reception region used to receive a large IC card of type ID-1 therein when the right and left movable covers are rotated 90 degrees of angle upward and outward, wherein guiding grooves are formed in two sides of the IC card reception region to provide a vertical and horizontal positioning effect to the IC card and a protrusion is provided as a stop at a farthest end from the IC card reception region to serve as a positioning point for the forwardly inserted IC card so that the IC card is guided to proceed and facilitated in a proper contact with the metal connector of the IC card seat. It provides a proper positioning effect.

7. The USB device according to claim 1, wherein a right movable cover and a left movable cover are disposed on an upper side of the IC card read/write module, the IC card reception region being extended to an extended IC card reception region used to receive a large IC card of type ID-1 therein when the right and left movable covers are rotated 180 degrees of angle upward and outward, wherein guiding grooves are provided in two sides of the extended IC card reception region and provides a vertical and horizontal positioning effect to the forwardly inserted IC card and a protrusion is provided as a stop at a farthest end from the extended IC card reception region to serve as a positioning point for the inserted IC card so that the IC card is guided to proceed and facilitated in a proper contact with the metal connector of the card seat. It provides a proper positioning effect.
